(19) United States
(12) Patent Application Publication
(10) Pub. No.: US 2010/0015389 A1
(43) Pub. Date: Jan. 21, 2010

(54) CONTAINER FLOORING MATERIAL AND METHOD OF MANUFACTURE

(75) Inventors: Qisheng Zhang, Edmonton (CA); Robert Wellwood, Edmonton (CA); Bin Xu, Edmonton (CA); Liheng Chen, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: ALBERTA RESEARCH COUNCIL INC., Edmonton (CA)

(21) Appl. No.: 12/175,235

(22) Filed: Jul. 17, 2008

(51) Int. Cl. B32B 21/14; B32B 21/10; B32B 38/00; B32B 37/02

(52) U.S. Cl. 428/106; 156/278; 156/148

(57) ABSTRACT

The present invention relates to a composite container floorboard having a structural strand-based board as the core material and its fabrication method thereof. It is characterized wherein the composite container floorboard, using a structural strand-based board as a core material, comprises 2 to 4 layers of wooden veneers coated or impregnated with resin, respectively, on a top and a bottom of the surface overlay materials; or comprises one piece of impregnated paper, one piece of resin-impregnated bamboo-woven mat, and 1 to 3 pieces of double-side resin-coated or resin-impregnated wooden veneers, respectively, from an exterior to an interior of the surface overlay materials; or comprises one Keruing or Apitong wooden veneer of Southeast Asia, or other wooden veneer with similar properties and 1 to 3 pieces of double-side resin-coated or resin-impregnated wooden veneers [or partially or entirely replacing wooden veneer(s) with resin-impregnated bamboo curtain(s) or bamboo-woven mat(s)], respectively, from an exterior to an interior of the surface overlay materials.

### FIELD OF THE INVENTION

The present invention relates to a composite container floorboard having a structural strand-based board as the core material and the fabrication method thereof.

### BACKGROUND OF THE INVENTION

The floorboard of the container is the main structural component and primarily dictates the load-bearing area of the container. Container floorboards must meet high requirements for mechanical performance, impact resistance, and durability. Tropical hardwood species such as Keruing and Apitong have been used to produce multi-layered thick plywood as container flooring by virtually the entire container industry. Considering that such tree species have a growing cycle as long as fifty years and even longer, the market supply for large-diameter Keruing and Apitong timber has dwindled as a result of the over-logging of primeval tropical rainforests.

The present invention has practical value to the protection of the worlds' ecology, the reduction in the consumption of tropical hardwood resources, the development of new types of floorboards for containers, and the widening of the sources of materials for container floorboard.

A primary object of the present invention is to provide a composite container floorboard having a structural strand-based board as the core material and the fabrication method thereof. In general, a suitable container floorboard must achieve a minimum of 12 to 15 years of service life and must be capable of withstanding repeated high horizontal shear loads applied through forklift truck wheels or other loading equipment, as expected and experienced in its normal operational environment. The wood species must match or exceed the performance of traditional apitong/keruing panels. Generally, suppliers are required to provide evidence of satisfactory performance for all plywood panels.

In part, the ability to withstand repeated high horizontal shear loads mandates a minimum thickness of about 28 mm, with a density of about 700 kgs-880 kgs/cubic meter.

Suitable container floorboards should demonstrate performance characteristics such as a short span test with loads greater than 1525 lbs. This is a three point bending test for estimating shear strength of the panels. The floorboards should also pass a floorboard strength test using a forklift vehicle. This test requires a test vehicle loaded with an axle load of 3630 kg per wheel (2 wheel load 7260 kg) to manoeuvre slowly over the board. Failure includes delaminating ply separation or cracks in the veneers.

### SUMMARY OF THE INVENTION

The present invention relates to a novel wood composite material suitable for use as container flooring. Rather than using completely high-density tropical hardwood species, the present invention utilizes fast growing bamboo species as well as fast-growing low-density wood species and tropical hardwood species veneers.

The present invention provides a method of using structural strand-based boards, which can be made of small-diameter logs, brushwood, timber harvesting and processing residuals, with high strength and modulus of elasticity (MOE), proper proportion between their longitudinal and traverse strength and MOE complied with certain requirements, and high shear resistance. Such structural strand-based boards are then applied as core materials in the floorboards of containers whilst materials such as wooden veneers, bamboo curtains, bamboo-woven mats and resin-impregnated paper are applied alone or compositely as surface overlay materials of the floorboard.

Therefore, in one aspect, the invention comprises a composite container floorboard having a structural strand-based board as core material, wherein a structural strand-based board being used as a core board comprises two to four layers of wooden veneers coated or impregnated with phenol-formaldehyde resin (or coated or impregnated with other weather-resistant resin) on a top and a bottom, respectively, of surface overlay materials; or comprises one piece of impregnated paper, one phenol-formaldehyde resin-impregnated (or other weather-resistant resin-impregnated) bamboo-woven mat, and one to three pieces of wooden veneers coated or impregnated with phenol-formaldehyde resin (or other weather-resistant resin) on double sides (or partially or entirely replacing wooden veneers with bamboo curtains impregnated with phenol-formaldehyde resin or other weather-resistant resin) from an exterior to an interior, respectively, of surface overlay materials; or comprises one piece of Keruing or Apitong wooden veneer or other species of wooden veneer with similar properties, and one to three pieces of wooden veneers coated or impregnated with phenol-formaldehyde resin (or other weather-resistant resin) on double sides (or partially or entirely replacing wooden veneers with bamboo curtains or bamboo-woven mats impregnated with phenol-formaldehyde resin (or other weather-resistant resin) from an exterior to an interior, respectively, of surface overlay materials.

The method of fabricating a composite container floorboard having a structural strand-based board as the core material comprises:
a. a step of selecting and treating wooden veneers, such that wooden veneers with moisture content of 12% or less and are coated or impregnated with phenol-formaldehyde resin on double sides of the wooden veneers with a spread of 250˜350 g/m²; the wooden veneers are treated through conditioning or low-temperature drying, and bamboo curtains and bamboo-woven mats are dried to a moisture content of less than 15% and impregnated with phenol-formaldehyde resin (or other weather-resistant resin) and treated through low-temperature drying, wherein a certain proportion of insecticide is added to the phenol-formaldehyde resin;
b. a step of forming a core board, wherein a substrate of the structural strand-based board is made into a core board (3) of the structural strand-based board after being configured into a board of constant thickness and being sanded to the thickness of about 20 mm to about 24 mm; and
c. a step of laying up, wherein materials such as wooden veneers, bamboo curtains, bamboo-woven mats and resin-impregnated paper are alone or compositely laid up onto the core board (3) of the structural strand-based board, before being hot pressed at a temperature ranging from 125 to 150° C. and at maximum pressure of 1.0˜4.0 MPa for five to ten minutes, sequentially stepping down the press pressure, degassing, and then relieving press pressure.

The present invention has the advantages of effectively utilizing various species at diverse diameters from China and the world. Examples include a great variety of softwood, hardwood, and bamboos from natural forests and plantation forests. These materials, upon applying alone or compositely and through scientific designs and logical combination, may overcome the shortage of worldwide hardwood resources. Additionally, the present invention has overcome the technical problem in connection with the mass production of new types of container floorboards that comply with the requirements of the international container industry. A structural strand-based board is made into a middle core layer of the container floorboard after being configured into a board of constant thickness and being sanded, whilst four to eight layers of wooden veneers, bamboo curtains, bamboo-woven mats and resin-impregnated paper are alone or compositely used as surface overlay materials of the core board. Some wooden veneers need to be coated (or impregnated) with phenol-formaldehyde resin (or other weather-resistant resin) on double sides whilst bamboo curtains and bamboo-woven mats need to be impregnated with phenol-formaldehyde resin (or other weather-resistant resin). Resin-impregnated paper is made by impregnating wood pulp with phenol-formaldehyde or melamine-formaldehyde or a hybrid resin of the above two and treating through low-temperature drying. A certain proportion of insecticides should preferably be added to the veneer resin, such that the veneer resin may evenly penetrate into the surface overlay materials on the floorboard of containers during hot pressing, thus making the floorboard long-term insecticidal. The core materials and the surface overlay materials are laid up and configured into the floorboard of containers through resination and hot pressing, such that various performance indicators such as their strength, modulus of elasticity, and other properties can completely comply with the technical requirements of the international container industry.

### BRIEF DESCRIPTION OF THE DRAWINGS

FIG. 1 shows one embodiment of the invention in cross-section. The floorboard has a core layer composed of strand-based wood composite. Item (1) is the surface layer of parallel-grained wood veneer layers; Item (2) is the cross-grained wooden veneer; and Item (3) is the strand-based wood composite.

FIG. 2 shows another embodiment of the invention in cross-section. The floorboard has a core layer composed of strand-based wood composite. Item (4) is the surface layer of paper impregnated with resin; Item (5) is the bamboo-woven mat layer; Item (6) is the wood veneer in the parallel-grained direction; and Item (3) is the strand-based wood composite.

FIG. 3 shows another embodiment of the invention in cross-section. The floorboard has a core layer composed of strand-based wood composite. Item (4) is the surface layer of paper impregnated with resin; Item (5) is the bamboo-woven mat layer; Item (7) is the bamboo curtains layer; and Item (3) is the strand-based wood composite.

FIG. 4 shows another embodiment of the invention in cross-section. The floorboard has a core layer composed of strand-based wood composite. Item (8) is the wood veneer layer made from Keruing or Apitong; Item (9) is the wood veneer layer; and Item (3) is the strand-based wood composite.

### DETAILED DESCRIPTION OF PREFERRED EMBODIMENTS

The present invention relates to a composite container floorboard having a structural strand-based board as the core material and its fabrication method thereof. Given that the structural strand-based board is used as a middle core layer after configuring it into a board of constant thickness and having it sanded, together with 4 to 8 layers of wooden veneers, bamboo curtains, bamboo-woven mats and resin-impregnated paper being applied alone or compositely as surface overlay materials thereof, the present invention has the advantages of: (1) increasing the sources of raw materials for container floorboard; and (2) producing composite container floorboard with consistent quality, strength and stiffness, and other properties and performances to meet the technical requirements of the international container industry.

When describing the present invention, all terms not defined herein have their common art-recognized meanings. As used herein, the term “about” refers to a margin of plus or minus 10%, or within the tolerance of a suitable measuring device or instrument. As used herein, “specific density” refers to density relative to water. All wood density refers to the density of oven-dried wood.

The term “weather proof resin” means a natural or synthetic resin which has adhesive and water-repellant properties. Weather proof resins include, without limitation, formaldehyde resins such as phenol-formaldehyde or melamine-formaldehyde resins.

The present invention relates to a hardwood veneer-wood composite board suitable for use as a container flooring material. In general terms, the invention comprises a multilayer board having a surface composite wooden veneer layer and a wood core layer.

The wood veneer layers comprises of wood veneers in either grain parallel or grain perpendicular orientation or in alternating parallel and perpendicular layers. As used herein, “grain parallel” refers to wood grain which is parallel to the longitudinal axis of the board. “Grain perpendicular” refers to wood grain which is perpendicular the longitudinal axis of the board. The wood veneer layers may be comprised of Keruing or Apitong or wood of similar properties such as pine, fir or eucalyptus.

The bamboo layer comprises bamboo strips sheets made of strips of bamboo and a suitable resin. The bamboo strips may be arranged so that the bamboo strips are all parallel, or parallel and perpendicular combination, or they may be layered or woven in a crisscrossing pattern. The bamboo layer may comprise of bamboo curtains made from strips of bamboo held together with string. The bamboo layer may also comprise a stripe sheet bamboo-woven mat made of strips of bamboo in a crisscrossing pattern and a suitable resin

The wood core layer comprises of a thick layer of wood strand, which comprises wood strand chips similar to those suitable for use in oriented strand boards. The wood strand layer may be oriented or non-oriented.

The wood core layer may preferably be comprised of any suitable low-density wood. Low density wood has a specific density of about 0.6 or less. Suitable wood species may include poplar, aspen, spruce, fir and pine. Preferably, the wood species is a fast growing species which may provide a plentiful and low-cost supply. The wood core layer may be comprised of a single tree species or a mixture of various tree species with similar properties.

In the Figures which illustrate exemplary embodiments of the invention, (1) refers to two to three layers of parallel-grained wooden veneers, respectively on a top and a bottom of surface overlay materials, coated (or impregnated) with phenol-formaldehyde resin on double sides and treated through low-temperature drying; (2) refers to one layer of cross-grained wooden veneer, respectively on a top and a bottom of surface overlay materials, coated (or impregnated) with phenol-formaldehyde resin on double sides and treated through low-temperature drying; (3) refers to a core board of the structural strand-based board; (4) refers to one layer of paper, respectively on a top and a bottom of surface overlay materials, impregnated with phenol-formaldehyde or melamine-formaldehyde (or impregnated with a hybrid resin of the phenol-formaldehyde and the melamine-formaldehyde); (5) refers to a layer of bamboo-woven mat, respectively on a top and a bottom of surface overlay materials, impregnated with phenol-formaldehyde resin and treated through low-temperature drying; (6) refers to two to three layers of parallel-grained wooden veneers, respectively on a top and a bottom of surface overlay materials, coated (or impregnated) with phenol-formaldehyde resin on double sides and treated through low-temperature drying; (7) refers to two layers of bamboo curtains impregnated with phenol-formaldehyde resin and treated through low-temperature drying (or replacing one layer of bamboo curtain with one layer of wooden veneer coated or impregnated with phenol-formaldehyde resin on double sides); (8) refers to a Keruing or an Apitong wooden veneer of Southeast Asia or other wooden veneer with similar properties; and (9) refers to one to two layers of wooden veneers coated or impregnated with phenol-formaldehyde resin on double sides and treated through low-temperature drying (or replacing one layer of wooden veneer with one layer of bamboo-woven mat or bamboo curtain impregnated with phenol-formaldehyde resin and treated through low-temperature drying).

In one embodiment, the invention comprises a wood composite material comprising low density wood species as raw materials. As shown in FIG. 1, the material includes at least two surface layers (1) of parallel-grained wooden veneers, a wood veneer layer (2) of perpendicular-grained wood veneer and a core layer of a wood strand layer (3). Preferably, the perpendicular-grained veneer layer (2) is adjacent the core layer (3). In one embodiment, the composite container floorboard is fabricated from veneers of pine (Larix gmelini or called Dahurian larch, Pinus massoniana Lamb. or called Chinese red pine and so on) a core board of a structural strand-based board (furnish from single tree species or a mixture of various tree species with similar properties), wherein one layer of cross-grained wooden veneer (2) coated (or impregnated) with phenol-formaldehyde resin on double sides and treated through low-temperature drying and two to three layers of parallel-grained wooden veneers (1) coated (or impregnated) with phenol-formaldehyde resin on double sides and treated through low-temperature drying are symmetrically formed, respectively, on a top and a bottom, of the core board of the structural strand-based board (3) sequentially.

In one example, the method of fabricating a composite container floorboard comprises:
a. a step of selecting and treating wooden veneers, such that wooden veneers contain moisture content of 12% or less and are coated or impregnated with phenol-formaldehyde resin on double sides of the wooden veneers with a spread of 250˜350 g/m²; the wooden veneers are conditioned until they are not viscous or they are treated through low-temperature drying until their moisture content becomes less than 12%; and 2.4 g insecticide is added to each kilogram of phenol-formaldehyde resin (solid content: 45%);
b. a step of forming a core board, wherein the structural strand-based board is made into a core board (3) of the structural strand-based board after being configured into a board of constant thickness and being sanded to thickness of about 20 mm to about 24 mm; and
c. a step of laying up, wherein two to three layers of parallel-grained wooden veneers (1) coated (or impregnated) with phenol-formaldehyde resin on double sides and treated through low-temperature drying and one layer of cross-grained wooden veneer (2) coated (or impregnated) with phenol-formaldehyde resin on double sides and treated through low-temperature drying are laid up onto a top and a bottom, respectively, of the core board (3) of the structural strand-based board before being hot pressed at a temperature ranging from 125 to 150° C. and at maximum pressure of 1.0˜4.0 MPa for five to ten minutes, sequentially stepping down the press pressure, degassing, and then relieving press pressure.

Upon standardized processing in the later phase, a finished composite container floorboard with physical and mechanical properties set out below is made:
MOR in parallel direction: ≧95 MPa
MOR in perpendicular direction: ≧30 MPa
MOE in parallel direction: ≧10500 MPa
MOE in perpendicular direction: ≧3000 MPa
Panel Density: 0.75˜0.90 g/cm³

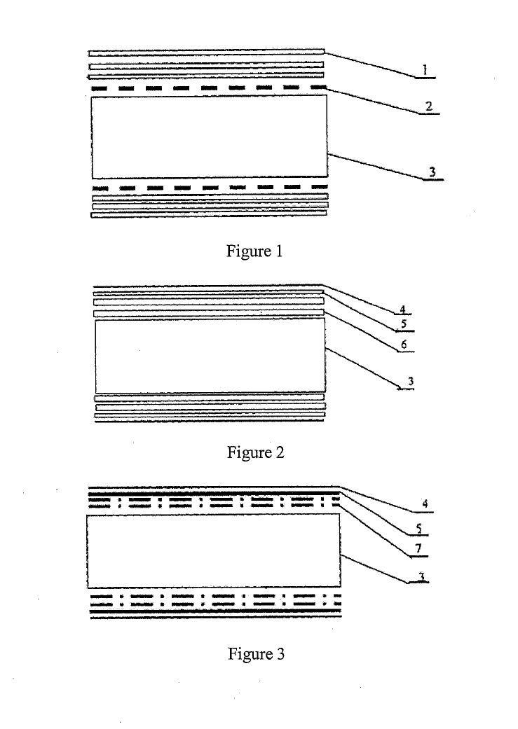

In another embodiment as shown schematically in FIG. 2, the floorboard comprises a surface paper layer impregnated with resin (4), a woven bamboo mat layer (5), a parallel-grained wood veneer layer (6) and a core layer of a wood strand layer (3).

The composite container floorboard is fabricated from phenol-formaldehyde resin-impregnated paper, bamboo-woven mats, wooden veneers and a structural strand-based board, wherein two layers of parallel-grained wooden veneers (6) coated (or impregnated) with phenol-formaldehyde resin on double sides and treated through low-temperature drying, one layer of bamboo-woven mat (5) impregnated with phenol-formaldehyde resin and treated through low-temperature drying and one layer of paper (4) impregnated with phenol-formaldehyde or melamine-formaldehyde (or impregnated with a hybrid resin of the phenol-formaldehyde and the melamine-formaldehyde) are symmetrically formed, respectively, on a top and a bottom, of the core board of the structural strand-based board sequentially.

In one example, the method of fabricating a composite container floorboard comprises:
a. a step of selecting and treating wooden veneers, such that wooden veneers contain moisture content of 12% or less and are coated or impregnated with phenol-formaldehyde resin on double sides of the wooden veneers with a spread of 250˜350 g/m²; the wooden veneers are conditioned until they are not viscous or they are treated through low-temperature drying until their moisture content becomes less than 12%; bamboo materials are processed into thin bamboo strips, which are further woven into a bamboo-woven mat, which is dried to contain less than moisture content of 15%; upon conditioning or low-temperature drying; 2.4 g insecticide is added to each kilogram of phenol-formaldehyde resin;
b. a step of forming a core board, wherein the structural strand-based board is made into a core board of the structural strand-based board after being configured into a board of constant thickness and being sanded to the thickness of about 20 mm to about 24 mm; and
c. a step of laying up, wherein one layer of paper (4) impregnated with phenol-formaldehyde or melamine-formaldehyde (or impregnated with a hybrid resin of the phenol-formaldehyde and the melamine-formaldehyde), a layer of bamboo-woven mat (5) impregnated with phenol-formaldehyde resin and treated through low-temperature drying, and two layers of parallel-grained wooden veneers (6), respectively coated (or impregnated) with phenol-formaldehyde resin on double sides and treated through low-temperature drying are laid up onto a top and a bottom, respectively, of a core board of the structural strand-based board (3), before being hot pressed at a temperature ranging from 125 to 150° C. and at maximum pressure of 1.0˜4.0 MPa for five to ten minutes, sequentially stepping down the press pressure, degassing, and then relieving the press pressure; or leading cool water to hot press platens until the press platens have cooled to a certain temperature, followed by press pressure relief.

Upon standardized processing in the later phase, a finished composite container floorboard with physical and mechanical properties set out below is made:
MOR in the parallel direction: ≧95 MPa
MOR in the perpendicular direction: ≧30 MPa
MOE in the parallel direction: ≧10000 MPa
MOE in the perpendicular direction: ≧3000 MPa
Panel Density: 0.75˜0.90 g/cm³

In another embodiment shown schematically in FIG. 3, the floorboard comprises a surface paper layer impregnated with resin (4), a woven bamboo mat layer (5), a bamboo curtain layer (7) and a core layer of a wood strand layer (3).

The composite container floorboard is fabricated from phenol-formaldehyde resin-impregnated paper, bamboo-woven mats, bamboo curtains, wooden veneers and a structural strand-based board, wherein two layers of bamboo curtains (7) impregnated with phenol-formaldehyde resin and treated through low-temperature drying, a layer of bamboo-woven mat (5) impregnated with phenol-formaldehyde resin and treated through low-temperature drying, and one layer of paper (4) impregnated with phenol-formaldehyde are symmetrically formed, respectively, on a top and a bottom, of the core board of the structural strand-based boards sequentially.

The method of fabricating a composite container floorboard comprises:
a. a step of selecting and treating wooden veneers, such that wooden veneers contain moisture content of 12% or less and are coated or impregnated with phenol-formaldehyde resin on double sides of the wooden veneers with a spread of 250˜350 g/m²; the wooden veneers are conditioned until they are not viscous or they are treated through low-temperature drying until their moisture content becomes less than 12%; bamboo materials are processed into thin bamboo strips, which are further woven into a bamboo-woven mat and a bamboo curtain, which are dried to contain less than moisture content of 15%; upon conditioned or low-temperature drying, 2.4 g insecticide is added to each kilogram of phenol-formaldehyde resin;
b. a step of forming a core board, wherein the structural strand-based board is made into a core board of the structural strand-based board after being configured into a board of constant thickness and being sanded to the thickness of about 20 mm to about 24 mm; and
c. a step of laying up, wherein one layer of paper (4) impregnated with phenol-formaldehyde or melamine-formaldehyde (or impregnated with a hybrid resin of the phenol-formaldehyde and the melamine-formaldehyde), one layer of bamboo-woven mat (5) impregnated with phenol-formaldehyde resin and treated through low-temperature drying and two layers of bamboo curtains (7) impregnated with phenol-formaldehyde resin and treated through low-temperature drying (or replacing one layer of bamboo curtain with one layer of wooden veneer coated or impregnated with phenol-formaldehyde resin on double sides) are laid up onto a top and a bottom, respectively of a core board of the structural strand-based board (3), before being hot pressed at a temperature ranging from 125 to 150° C. and at maximum pressure of 1.0˜4.0 MPa for five to ten minutes, sequentially stepping down the press pressure, degassing, and then relieving press pressure; or leading cool water to hot press platens until the press platens have cooled to a certain temperature, followed by press pressure relief.

Upon standardized processing in the later phase, a finished composite container floorboard with physical and mechanical properties set out below is made:
MOR in the parallel direction: ≧100 MPa
MOR in the perpendicular direction: ≧30 MPa
MOE in the parallel direction: ≧10500 MPa
MOE in the perpendicular direction: ≧3000 MPa
Panel Density: 0.75˜0.90 g/cm³

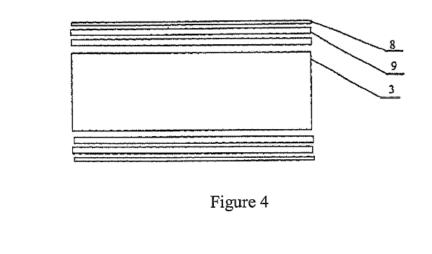

In another embodiment shown schematically in FIG. 4, the floorboard comprises a surface wood veneer layer (8), a wood veneer layer (9) and a core layer of a wood strand layer (3).

The composite container floorboard is fabricated from a Keruing wooden veneer, other wooden veneers, bamboo curtains, bamboo-woven mats, and a structural strand-based board, wherein one to two layers of wooden veneers (9) coated or impregnated with phenol-formaldehyde resin on double sides and treated through low-temperature drying and a Keruing or Apitong wooden veneer (8) of Southeast Asia are symmetrically formed, respectively, on a top and a bottom, of the core board of the structural strand-based boards sequentially.

The method of fabricating a composite container floorboard comprises:
a. a step of selecting and treating wooden veneers, such that a Keruing or an Apitong wooden veneer (8) (or other wooden veneers with similar properties) with moisture content equal to or less than 12% and one to two layers of wooden veneers coated or impregnated with phenol-formaldehyde resin on double sides and treated through low-temperature drying (or replacing one layer of wooden veneer (9) with one layer of bamboo-woven mat or bamboo curtain impregnated with phenol-formaldehyde resin and treated through low-temperature drying);
b. a step of forming a core board, wherein the structural strand-based board is made into a core board of the structural strand-based board after being configured into a board of constant thickness and being sanded to the thickness of about 20 mm to about 24 mm; and
c. a step of laying up, wherein a Keruing or an Apitong wooden veneer (8) of Southeast Asia (or other wooden veneer with similar properties) and one to two layers of wooden veneers (9) coated or impregnated with phenol-formaldehyde resin on double sides and treated through low-temperature drying (or replacing one layer of wooden veneer with one layer of bamboo-woven mat or bamboo curtain impregnated with phenol-formaldehyde resin and treated through low-temperature drying) are laid up onto a top and a bottom, respectively, of a core board of the structural strand-based board (3), before being hot pressed at a temperature ranging from 125 to 150° C. and at maximum pressure of 1.0˜4.0 MPa for five to ten minutes, sequentially stepping down the press pressure, degassing, and then relieving the press pressure.

Upon standardized processing in the later phase, a finished composite container floorboard with physical and mechanical properties set out below is made:
MOR in the parallel direction: ≧95 MPa
MOR in the perpendicular direction: ≧30 MPa
MOE in the parallel direction: ≧10500 MPa
MOE in the perpendicular direction: ≧3000 MPa
Panel Density: 0.75˜0.90 g/cm³

In one embodiment, where bamboo layers are not used, the floorboard may be formed in a conventional press suitable for producing plywood, up to pressures of about 1.0 to about 2.0 MPa. If a bamboo layer is incorporated into the floorboard, higher pressing pressures may be required, preferably up to about 4.0 MPa.

As will be apparent to those skilled in the art, various modifications, adaptations and variations of the forgoing specific disclosure can be made without departing from the scope of the invention claimed herein. The various features and elements of the described invention may be combined in a manner different from the combinations described or claims herein, without departing from the scope of the invention.

What is claimed is:

1. A composite container floorboard having a structural strand-based board as core material, characterized wherein one layer of cross-grained wooden veneer coated or impregnated with a weather proof resin on double sides and treated through low-temperature drying and 2 to 3 layers of parallel-grained wooden veneers coated (or impregnated) with a weather proof resin on double sides and treated through low-temperature drying are formed symmetrically and successively on a top and a bottom of a core board of said structural strand-based board, respectively.

2. The composite container floorboard as claimed in claim 1, wherein two layers of parallel-grained wooden veneers, one layer of bamboo-woven mat impregnated with phenol-formaldehyde resin and treated through low-temperature drying and one layer of paper impregnated with a weather proof resin are formed symmetrically and successively on a top and a bottom of a core board of said structural strand-based board, respectively.

3. The composite container floorboard as claimed in claim 1, wherein two layers of bamboo curtains impregnated with a weather proof resin and treated through low-temperature drying (or replacing one layer of bamboo curtain with one layer of wooden veneer coated or impregnated with a weather proof resin on double sides and one layer of bamboo-woven mat impregnated with a weather proof resin and treated through low-temperature drying, and one layer of paper impregnated with a weather proof resin are formed symmetrically and successively on a top and a bottom of a core board of said structural strand-based board, respectively.

4. The composite container floorboard as claimed in claim 1, wherein one to two layers of wooden veneers coated or impregnated with a weather proof resin on double sides and treated through low-temperature drying and one layer of Keruing or Apitong wooden veneer are formed symmetrically and successively on a top and a bottom of a core board of said structural strand-based board, respectively.

5. The composite container floorboard of one of claims 1-4, wherein the weather proof resin comprises a phenol-formaldehyde or a melamine-formaldehyde resin, or a mixture thereof.

6. A method of fabricating a composite container floorboard having a structural strand-based board as the core material, comprising:
a. a step of selecting and treating wooden veneers, such that wooden veneers with moisture content of 12% or less and are coated or impregnated with a weather proof resin on double sides of said wooden veneers with a spread of 250˜350 g/m²; and said wooden veneers are treated through conditioning or low-temperature drying, with a certain proportion of insecticide added to said resin;
b. a step of forming a core board, wherein a substrate of said structural strand-based board is made into a core board after being configured into a board of constant thickness and being sanded to the thickness of 24 mm; and
c. a step of laying up, wherein 2 to 3 layers of parallel-grained wooden veneers coated or impregnated with a weather proof resin on double sides and treated through low-temperature drying and one layer of cross-grained wooden veneer coated or impregnated with a weather proof resin on double sides and treated through low-temperature drying are laid up onto a top and a bottom, respectively, of said core board of said structural strand-based board before being hot pressed at a temperature ranging from 125 to 150° C. and at maximum pressure of 1.0˜4.0 MPa for 5 to 10 minutes, sequentially stepping down the press pressure, degassing, and then relieving press pressure.

7. The method of fabricating a composite container floorboard as claimed in claim 6, wherein said step (c) further comprises a sub-step of laying up one layer of paper impregnated with a weather proof resin, one layer of bamboo-woven mat impregnated with phenol-formaldehyde resin and treated through low-temperature drying, and two layers of parallel-grained wooden veneers coated or impregnated with a weather proof resin on double sides and treated through low-temperature drying onto a top and a bottom, respectively, of said core board of said structural strand-based board, wherein said bamboo-woven mat is woven by processing bamboo materials into thin bamboo strips.

8. The method of fabricating a composite container floorboard as claimed in claim 6, wherein said step (c) further comprises a sub-step of laying up one layer of paper impregnated with a weather proof resin, one layer of bamboo-woven mat impregnated with a weather proof resin and treated through low-temperature drying, and two layers of bamboo curtains impregnated with a weather proof resin and treated through low-temperature drying (or replacing one layer of bamboo curtain with one layer of wooden veneer coated or impregnated with a weather proof resin on double sides) onto a top and a bottom, respectively, of said core board of said structural strand-based board.

9. The method of fabricating a composite container floorboard as claimed in claim 6, wherein said step (c) further comprises a sub-step of laying up a Keruing or an Apitong wooden veneer, and 1 to 2 layers of wooden veneers coated or impregnated with a weather proof resin on double sides and treated through low-temperature drying (or one layer of bamboo-woven mat or bamboo curtain impregnated with a weather proof resin treated through low-temperature drying) onto a top and a bottom, respectively, of said core board of said structural strand-based board.

10. The method of fabricating a composite container floorboard as claimed in claim 6, wherein said structural strand-based board being used as a core layer comprises two to four layers of wooden veneers coated or impregnated with a weather proof resin, respectively, on a top and a bottom of surface overlay materials; or comprises one piece of impregnated paper, one bamboo-woven mat coated or impregnated with a weather proof resin, and 1 to 3 pieces of wooden veneers coated or impregnated with a weather proof resin on both sides, respectively, from an exterior to an interior of surface overlay materials; or comprises one piece of Keruing or Apitong wooden veneer, and 1 to 3 pieces of wooden veneers coated or impregnated with a weather proof resin on double sides (or partially or entirely replacing wooden single board(s) with resin-impregnated bamboo curtain(s) or bamboo-woven mat(s)), respectively, from an exterior to an interior of surface overlay materials.

11. The method of one of claims 6-10, wherein the weather proof resin comprises a phenol-formaldehyde or a melamine-formaldehyde resin, or a mixture thereof.
